(19) United States
(12) Patent Application Publication
(10) Pub. No.: US 2002/0121559 A1
(43) Pub. Date: Sep. 5, 2002

(54) Method and device for recovering permeability of porous pavement surface layer

(76) Inventor: Shin Narui, Tokyo (JP)

Correspondence Address: SCULLY, SCOTT, MURPHY & PRESSER, 400 Garden City Plaza, Garden City, NY, 11530, US

(21) Appl. No.: 10/135,304

(22) Filed: Apr. 30, 2002

Related U.S. Application Data
(63) Continuation of application No. 09/418,543, filed on Oct. 14, 1999.

(30) Foreign Application Priority Data
Jan. 12, 1999 (JP) 11-005825
May 20, 1999 (JP) 11-140803

(51) Int. Cl. B05B 1/20

(52) U.S. Cl. 239/1; 239/159

(57) ABSTRACT

The present invention relates to a method for recovering water permeability of a pavement surface layer of drainage or water permeable pavement by removing clogging of air voids in the pavement surface layer, comprising the step of: discharging water jet at a high pressure from a nozzle onto a surface of the pavement surface layer so that the surface of the pavement surface layer is within a droplet flow region of the water jet and that droplets and globules in the droplet flow region enter the air voids in the pavement surface layer to cause water hammer which removes the clogging of the pavement surface layer.

### BACKGROUND OF THE INVENTION

1. Field of the Invention

This invention relates to a method for recovering water permeability of a porous pavement surface layer of drainage or water permeable pavement by removing clogging of air voids in the pavement surface layer and to a device therefore.

This application is based on Japanese Patent Applications Nos. Hei 11-005825 and Hei 11-140803, the contents of which are incorporated herein by reference.

2. Background Art

As is well known, porous pavement is effective to improve high speed driving safety and reduces road noise because rain water does not stay on the pavement surface when it rains, and is widely used particularly on highways. Permeable pavement, applied to sidewalks, promenades, parks, etc., allows rainwater to permeate to roadbeds, restricts surface drainage, and recharges underground water.

A surface pavement material used for porous pavement (porous asphalt pavement) and permeable pavement is 40 to 50 mm in thickness, and has more air voids than ordinary asphalt pavement. As the air voids are continuous, the permeable paths are formed. However, dust and soil may easily clog the air voids in the surface layer, and may drastically reduce the permeability. To maintain the permeability, the pavement requires periodical and frequent cleaning to remove the clogging.

Therefore, a device for recovering the permeability of the drainage and permeable pavement is generally demanded. A water jet cleaning machine for discharging cleaning water at a high pressure, for example, at 10 MPa (100 bar) to the surface of the pavement, a device using a vacuum pump, and a device using also a cleaning agent are in use and in development.

These devices, however, cannot satisfactorily recover the function of the pavement. Particularly, when the surface layer is thick, the clogging around the surface can be removed, but the deep clogging remains. Therefore, the conventional devices cannot sufficiently recover the permeability.

### SUMMARY OF THE INVENTION

It is therefore an object of the present invention to provide a method which enhances the effect of the recovery of the water permeability and a device therefore.

The method recovers the water permeability of a pavement surface layer of drainage or water permeable pavement by removing clogging of air voids in the pavement surface layer. The method comprises discharging water jet at a high pressure from a nozzle onto a surface of the pavement surface layer so that the surface of the pavement surface layer is within a droplet flow region of the water jet and that droplets and globules (lumps) in the droplet flow region enter the air voids in the pavement surface layer to cause water hammer which removes the clogging of the pavement surface layer.

The method for recovering the function of the pavement surface layer discharges the water jet at the high pressure onto the surface of the pavement surface layer so that the surface is within the droplet flow region. Then, the fine droplets and globules enter the air voids from the surface of the pavement surface layer, causing water hammer, which ejects the contaminants to the surface, pushes the contaminants out of the spaces, or crushes the contaminants, thereby removing the clogging and recovering the water permeability efficiently. As long as the surface is within the droplet flow region, the nozzle type, the nozzle diameter, the discharge pressure, the standoff distance, and the amount of water may be freely changed so that the recovery of the water permeability becomes most effective.

The discharge pressure at the nozzle is within 20 to 70 MPa, and the dimensionless standoff distance obtained by dividing the real standoff distance between the nozzle and the pavement surface layer by the diameter of the nozzle is within 200 to 600. This invention effectively removes the clogging in the pavement surface layer.

The water jet is discharged obliquely to cause a water flow in one direction on the surface of the pavement surface layer, the water flow washing away contaminants which are pushed out from the air voids in the pavement surface layer to the surface by the water hammer. By discharging the water jet slightly obliquely onto the pavement surface layer, the water naturally flows in one direction, thereby removing the contaminants pushed out from the air voids by the water hammer.

In another aspect of the invention, the device for recovering water permeability of a pavement surface layer of drainage or water permeable pavement by removing clogging of air voids in the pavement surface layer, comprises: a truck for running on a target paved surface; and a nozzle mechanism having a nozzle for discharging a water jet at a high pressure. The standoff distance between the nozzle and the pavement surface layer is set so that the surface of the pavement surface layer is within the droplet flow region of the water jet. This device can perform the above method efficiently. Further, in comparison with the conventional device for recovering the permeability, the present invention shortens the time required for the process and can cover a wider area.

The nozzle mechanism comprises: a rotational axis; and a plurality of rotors attached to the rotational axis to form a radial pattern. The nozzles are attached to the undersides of the rotors, and as the rotational axis is rotated, the nozzles draw circles in a plane parallel to the surface of the pavement surface layer. Therefore, as the nozzles are rotated and the truck travels, the water jets from the nozzles are sprayed over the entire pavement surface layer, drawing spiral loci. This enhances the effect in the recovery of the function of the pavement surface layer.

A plurality of the nozzle mechanisms are aligned perpendicularly to the travel direction of the truck, and the intervals between the nozzle mechanisms are determined so that the circles, which are drawn by the water jets from the nozzles as the nozzle mechanisms are rotated, overlap. The water jet is widely sprayed over the entire pavement surface layer.

The nozzle mechanism comprises a pipe extending horizontally. A plurality of the nozzles are attached to an underside of the pipe at predetermined intervals in the direction of extension of the pipe. The pipe is reciprocated so that the nozzles are reciprocated in a plane parallel to the surface of the pavement surface layer. By the reciprocation of the pipe and the travel of the truck, the water jets are discharged over the entire pavement surface layer, enhancing the recovery of the pavement surface layer.

A plurality of the nozzles are attached to the nozzle mechanism, and orifice-type nozzles and fan-type nozzles are used together as the nozzles. Therefore, the droplets are widely dispersed and efficiently enter the air voids, thereby enhancing the recovery of the function of the pavement surface layer.

The device further comprises a casing, which is open at the bottom, for including the nozzle mechanism. The casing prevents scattering of the water jet around the device.

The device further comprises a vacuum evacuator for evacuating the casing. The evacuator forcibly removes the water remaining on the surface of the pavement surface layer, preventing the water from flowing around and the pavement surface layer from being clogged again.

### BRIEF DESCRIPTION OF THE DRAWINGS

FIGS. 1A and 1B are diagrams showing the structure of water jet discharged from a nozzle at a high pressure.

FIG. 2 is a graph showing the effect of water hammer caused by the droplets in the water jet.

FIG. 3 is a side view showing the structure of the device for recovering the permeability of the first embodiment of the present invention.

FIG. 4 is a front view showing the structure of the device for recovering the permeability of the first embodiment of the present invention.

FIG. 5 is a bottom view showing the structure of the device for recovering the permeability of the first embodiment of the present invention.

FIG. 6A is a diagram showing the process of the function recovery test for a car park by the present invention, and

FIG. 6B is a table showing results thereof.

FIG. 7 is a table showing the results of the water permeability recovery test for a wheel track, a non-wheel track, and a shoulder of a highway paved with a drainage material by the present invention.

FIG. 8 is a diagram showing the process for a road by the device of the present invention.

FIG. 9 is a diagram showing the process for a road shoulder by the device of the present invention.

FIGS. 10A and 10B are diagrams showing the device for recovering the permeability of the second embodiment of the present invention.

FIGS. 11A and 11B are diagrams showing the device for recovering the permeability of the third embodiment of the present invention.

### DETAILED DESCRIPTION OF THE PREFERRED EMBODIMENTS

The best mode of the present invention will be explained. The method for recovering the permeability of the pavement surface layer according to the present invention discharges water at a pressure (20 to 70 MPa as described below) which is sufficiently higher than that in the conventional high pressure cleaning process. The present invention discharges a water jet onto the surface of the pavement surface layer to remove clogging of the air voids and to recover the water permeability. As is well known, water jet techniques are generally applied for surface preparation, demolishing, cutting or hole drilling of concrete material. When this conventional water jet technique is naturally applied to clean the road surface, the pavement surface layer may be damaged. The present invention basically differs from the known high pressure cleaning processes and the water jet processes, and removes the clogging while protecting the pavement surface layer based on the theory of fluid mechanics and impact engineering mentioned below.

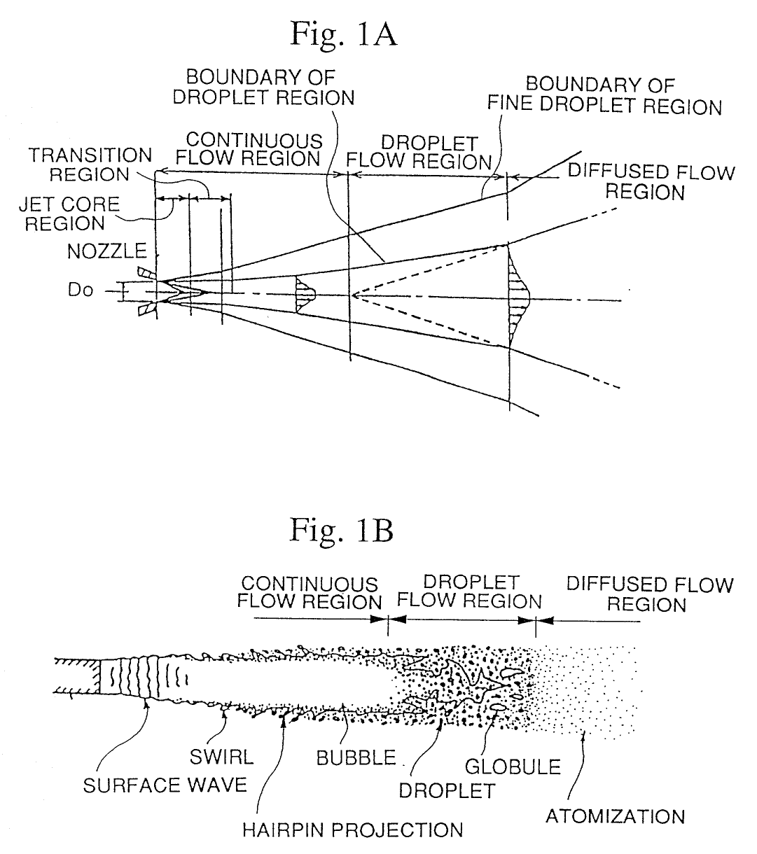

When a water jet is discharged at a high pressure into air, the water jet shows the structure as shown in FIG. 1A (Katsuya Yanaida, and Akira Ohashi, “Research of Flow Characteristics of Water Jet in Air, Atomized Droplet Region, No. 2”, Japan Mining Bulletin, 93-1073 (1977), 489). The water jet in the air is generally divided into three regions: a continuous flow region in which the water jet maintains continuity, a droplet flow region in which the water jet loses the continuity and becomes water droplets or globules, and a diffused flow region in which the water jet is atomized to produce mist.

Specifically, as shown in FIG. 1B, the water jet just after discharge from a nozzle has a smooth surface, and immediately produces surface waves. The amplitudes of the surface waves gradually become higher as the water jet flows downstream. Downstream of the surface waves, the surface unstably swirls, and then the fronts of the highly enlarged surface waves are doubled over, forming hairpin projections, while the air enters the water jet and the surface becomes disturbed by a number of air bubbles. In the downstream droplet flow region, the wave tips of the disturbed surface separate and become fine droplets and globules. This fragmentation gradually expands toward the center of the jet so that the water jet is fragmented into droplets and globules. The droplets and globules are further fragmented and finally are changed into a micro mist in the downstream diffused flow region. According to observation by a microscope, the droplets produced in the droplet flow region are approximately spherical because of their surface tension. The globules are more irregular in shape than the droplets, and the size of the globule is in a range of 10 to 100 μm.

The present invention focuses on the droplets and globules produced in the droplet flow region in the water jet. The invention discharges the water jet onto the surface of the pavement surface layer so that the surface is within the droplet flow region and that a number of the fine droplets and globules enter the air voids and collide against the particles (contaminants). Then, water hammer efficiently removes the clogging of the air voids. Although there are differences in size between the droplets and the globules, the water hammer is actually caused by both, and hereinafter both droplets and globules are generally referred to as droplets.

The water hammer by the droplets, which includes globules, will now be explained. The impact pressure (water hammer pressure) Pw caused by the droplets hitting the target contaminants is obtained from the equation:

Pw=ρcV

where V is the discharge velocity at the nozzle exit. V can be obtained based on a discharge pressure P at the nozzle exit from the equation:

V=(2P/ρ)^{½}(Bernoulli's formula)

where ρ is a water density (in general, 10³ kg/m³), and c is the speed of sound in water (in general, 1400 m/s).

From the above equations, when the discharge pressure P is 45 MPa, the discharge velocity V becomes 300 m/s, and the water hammer pressure Pw becomes 420 MPa. That is, the water hammer pressure Pw by the droplets is approximately ten times the discharge pressure P at the nozzle exit.

On the other hand, the water hammer power is not considerably high because the droplets are small, that is, 10 to 100 μm in diameter. The water hammer power by the droplet is obtained by the product of the water hammer pressure Pw and the cross sectional area of the droplet. If the droplet has a square cross section with 100 μm square, the water hammer power based on the above water hammer pressure Pw is merely 4.2 N (0.42 kgf). This water hammer power does not cause any damage to the pavement surface layer. The diameters of the droplets are significantly smaller than those of the air voids so that the droplets surely enter the air voids.

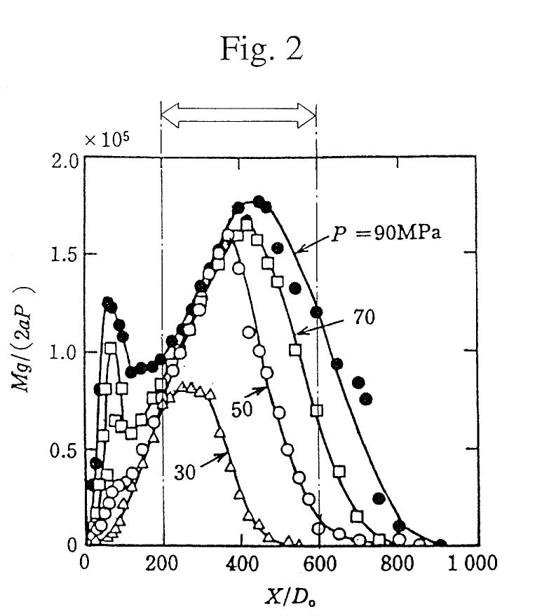

FIG. 2 shows the results of an experiment for proving the water hammer effect by the droplets. FIG. 2 shows the variation of a mass loss M of a sample metal, in this case, aluminum, depending on a distance X from the nozzle opening to the sample (Ryoji Kobayashi, “High Speed Water Jet Cutting of Solid Material (Research and Outlook)”, Report Collection of Japan Society of Mechanical Engineers, Edition B, 52-483(1986), 3645). The inner diameter D₀ of the nozzle opening is 1 mm, and the discharge time is 60 seconds. Further, “a” is a nozzle cross sectional area, “g” is the gravity, and “P” is a discharge pressure measured upstream of the nozzle. In FIG. 2, the axis of ordinates indicates a dimensionless value obtained by dividing the mass loss M under the discharge pressure of 30 MPa, 50 MPa, 70 MPa, or 90 MPa by a momentum (2 aP) of the jet stream. The axis of abscissas indicates a dimensionless standoff distance obtained by dividing the distance X by the nozzle opening diameter D₀.

In FIG. 2, the mass losses M have first peaks near the nozzle and second peaks distant from the nozzle. The first peaks are caused by the hydrowedge effect in the continuous flow region in the jet stream, and the second peaks are caused by the water hammer arising from the collision of the droplets. The range before and after the second peaks corresponds to the droplet flow region in the high pressure water jet. The water hammer which frequently occurs in this range is effective to remove the clogging in the pavement surface layer.

Based on the above analysis, the method for recovering the permeability of the pavement surface layer according to the present invention discharges the water jet from the nozzle at a high pressure onto the surface of the pavement surface layer so that the surface is within the droplet flow region. Specifically, the dimensionless standoff distance indicated by the axis of abscissas in FIG. 2 (the value obtained by dividing the standoff distance X by the nozzle diameter D₀) is set within the range around the second peaks, that is, 200 to 600. When the nozzle diameter D₀ is, for example, 1 mm, the standoff distance X is set to 20 to 60 cm. When the discharge pressure P is below 20 MPa, the water hammer is reduced and the effect may be unsatisfactory. Therefore, the discharge pressure P is preferably set to 20 to 70 MPa, and more preferably, to 30 to 70 MPa. The necessary amount of water is naturally determined based on the water pressure and the nozzle diameter, and approximately 40 to 200 lit/min. of water may be sufficient.

The pressure of 20 to 70 MPa is considerably higher than those in the conventional high pressure cleaning processes (which in general employ approximately lower than 10 MPa), and is considerably lower than those in the conventional water jet processes (which in general employ more than 100 MPa). The conventional high pressure cleaning processes and water jet processes use the continuous flow region, in particular, a jet core just after the nozzle (as shown in FIG. 1A) and do not include the idea of using the droplet flow region. Therefore, these conventional techniques normally set the standoff distance to several centimeters. The standoff distance of 20 to 60 cm in the embodiment (when the nozzle diameter is 1 mm) is considerably greater than those in the conventional techniques.

The method for recovering the permeability of the pavement surface layer discharges the water jet at a high pressure onto the surface of the pavement surface layer by the above standoff distance, so that the fine droplets in the droplet flow region enter the air voids from the surface of the pavement surface layer at a high speed, and collide hard against the contaminant in the air voids. Then, the water hammer ejects the contaminants off to the surface, pushes the contaminants out of the spaces, or crushes the contaminant, thereby removing the clogging and recovering the permeability efficiently.

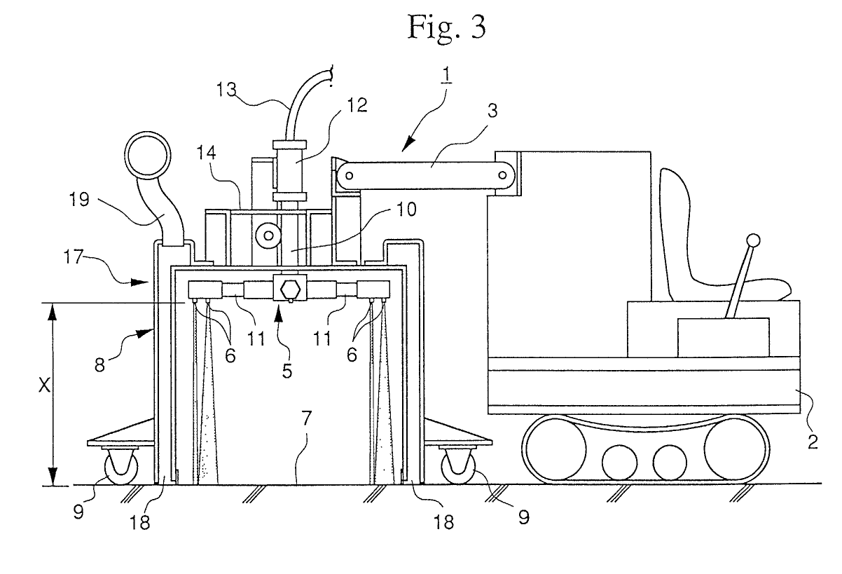

FIGS. 3 to 5 show the first embodiment of the device for recovering the permeability of the pavement surface layer of the drainage road. As shown in FIG. 3, a truck 1 which runs on a target road is coupled to a self-propelled car 2 by a connecting means 3, and is pulled or pushed by the car 2. On the truck 1 is loaded a nozzle mechanism 5 for discharging the water jet. A nozzle 6 of the nozzle mechanism 5 discharges the water jet onto the surface of the pavement surface layer 7 so that the surface is within the droplet flow region.

The truck 1 has a casing 8 which is open at the bottom. A vertically movable nozzle mechanism 5 is positioned in an upper area in the casing 8. By changing the vertical position of the nozzle mechanism 5, the standoff distance X can be appropriately set. Reference numerals 9 denote wheels attached to the underside of the casing 8. Alternatively, the nozzle mechanism 5 may be fixed to the casing 8 and the casing 8 may be moved in the vertical direction to adjust the standoff distance X. In this case, the casing 8 may be extensible.

The embodiment has four nozzle mechanisms 5 aligned perpendicularly to the traveling direction of the truck 1. In each nozzle mechanism 5, four rotors 11 are attached radially to the lower end of a rotation axis 10, forming a cross-shape. Two nozzles 6 are attached to the underside of the end of each rotor 11. To the upper end of the rotation axis 10, a supply hose 13 for the water jet is connected via a swivel joint 12. The water jet is pumped by a high pressure pump, which is not shown, is supplied through the supply hose 13, the swivel joint 12, the rotation axis 10, and the rotors 11 to the nozzles 6, and is discharged from the nozzles 6 at a high pressure onto the surface of the pavement surface layer 7. All the nozzle mechanisms 5 are supported by a frame 14 attached to the upper side of the casing 8, and are rotated horizontally at the same speed by an oil hydraulic motor 15 and a power transmission mechanism 16.

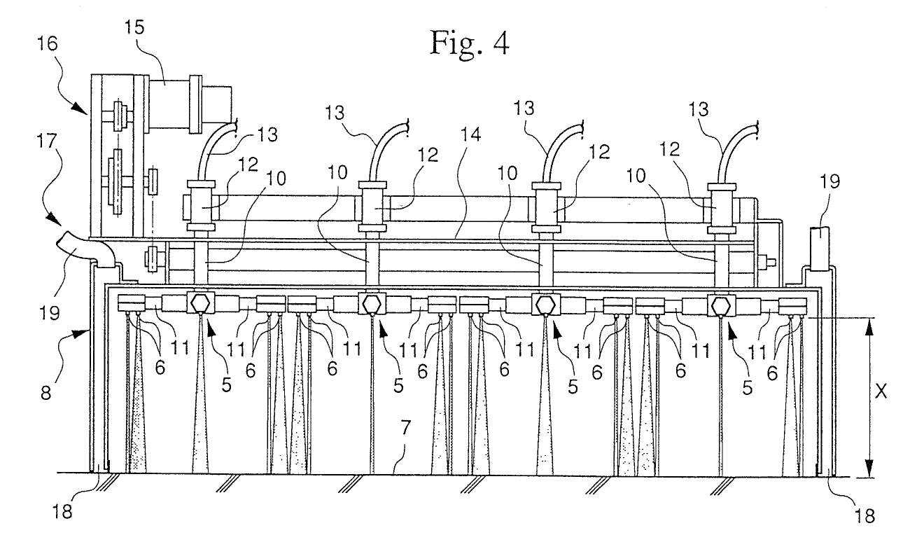

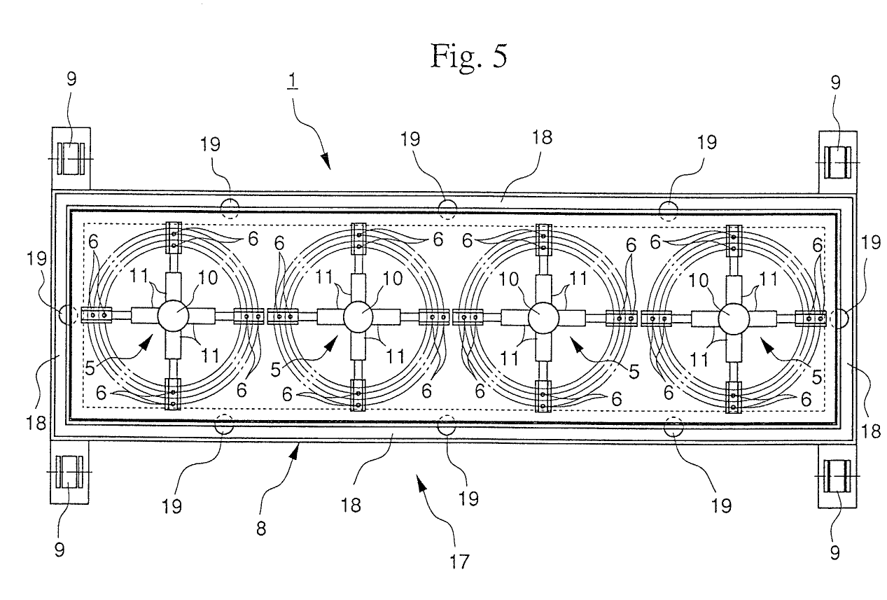

As the rotors 11 are rotated, the water jet discharged from the nozzles 6 follows a circular locus having a center corresponding to the rotation axis 10. Since each nozzle mechanism 5 has the four rotors 11 and each rotor 11 has two nozzles 6, each nozzle mechanism 5 has in total eight nozzles 6. These eight nozzles 6 draw quadruple concentric circles, as shown in FIG. 5 (as seen from the bottom side to the casing 8). As shown in FIG. 4, the circles corresponding to the neighboring outermost nozzles 6 overlap.

One of the nozzle pairs 6 attached to rotors 11 is a general orifice-type nozzle (circular jet nozzle), while the other is a fan-type nozzle (fan jet nozzle) for discharging the water jet over a wider area. The droplets from the fan-type nozzle are widely dispersed in the droplet flow region of the water jet so that the droplets effectively enter the air voids. The nozzle diameter Do of the orifice-type nozzle 6 is 1 mm, and the nozzle diameter Do of the fan-type nozzle 6 is 1.2 mm. Accordingly, the standoff distance X is appropriately set to a value obtained by multiplying the nozzle diameter D₀ by 200 to 600, that is, within 20 to 72 cm.

Because the nozzles 6 are enclosed by the casing 8, scattering of water from the nozzle 6 is limited. Most water sprayed onto the surface of the pavement surface layer 7 is naturally drained off through the pavement surface layer 7 which recovers the water permeability, and a little water remains on the pavement surface layer 7. To forcibly remove the remaining water, the casing 8 has a vacuum evacuator 17. The vacuum evacuator 17 comprises a slit 18 for vacuum evacuation formed between double walls of the casing 8 and along the edge of the casing 8. Through the slit 18, vacuum exhaust pipes 19 evacuate the casing 8 to prevent water from flowing around, and suck up dust and soil with the water to prevent clogging of the pavement surface layer. The number and positions of the vacuum exhaust pipes 19 are appropriately modified. The sucked water may be supplied through a filter and may be recycled.

To recover the permeability of the pavement surface layer 7 of the drainage road using the above device, since the nozzle diameter D₀ of the nozzle 6 is within 1 to 1.2 mm, the standoff distance X is 20 to 72 cm obtained by multiplying the diameter by 200 to 600. Further, the discharge pressure P is 20 to 70 MPa, the amount of water is 40 to 200 l/min., the rotation speed of the nozzle mechanisms 5 is, for example, 300 rpm, and the traveling speed of the truck 1 is 4 m/min. As the nozzle mechanisms 5 are rotated and the truck 1 travels, the water jets from the nozzles 6 are discharged over the surface of the pavement surface layer 7, tracing spiral loci. The fine droplets in the droplet flow region of the water jet enter the air voids in the pavement surface layer, permeate deeply therethrough, intermittently collide against the contaminants, causing water hammer, which ejects the contaminants to the surface, pushes the contaminants out of the air voids, or crushes the contaminants, thereby removing the clogging and effectively recovering the water permeability.

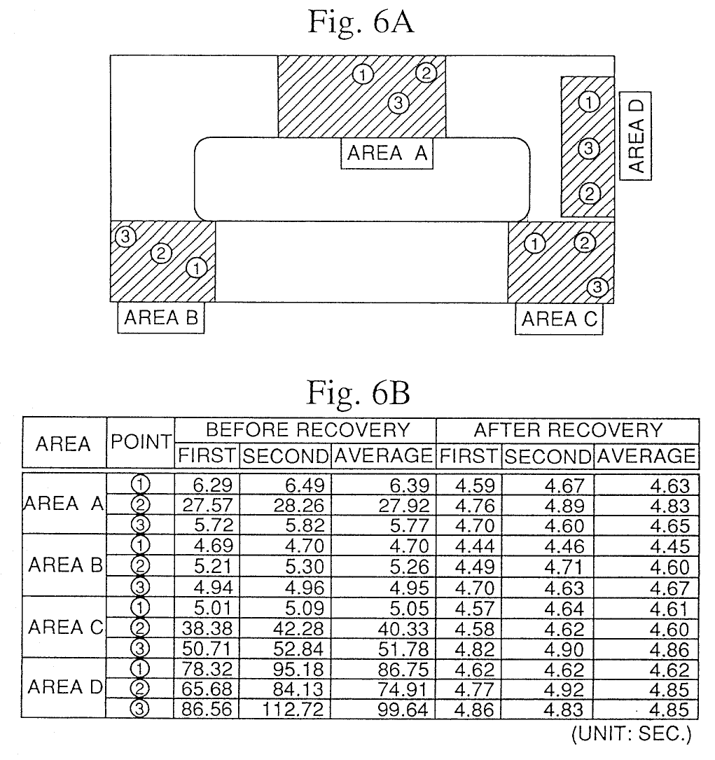

FIG. 6 shows the result of the water permeability recovery test by the above device. The test was conducted at twelve points in four areas of a car park paved with a porous material 40 mm in thickness, and compares the water permeability before and after the process (the time in seconds required to drain 400 ml of water through the drainage material). As is obvious from the results, even for the points which required several tens of seconds to drain the water because of the clogging, after the clogging was eliminated by the recovery, the time was shortened to less than 5 seconds. Thus, this invention is considerably effective. Since, according to the standard of the water permeability of the drainage surface, 400 ml permeate within 10 seconds or 800 ml permeate within 15 seconds, the above results satisfy the standard.

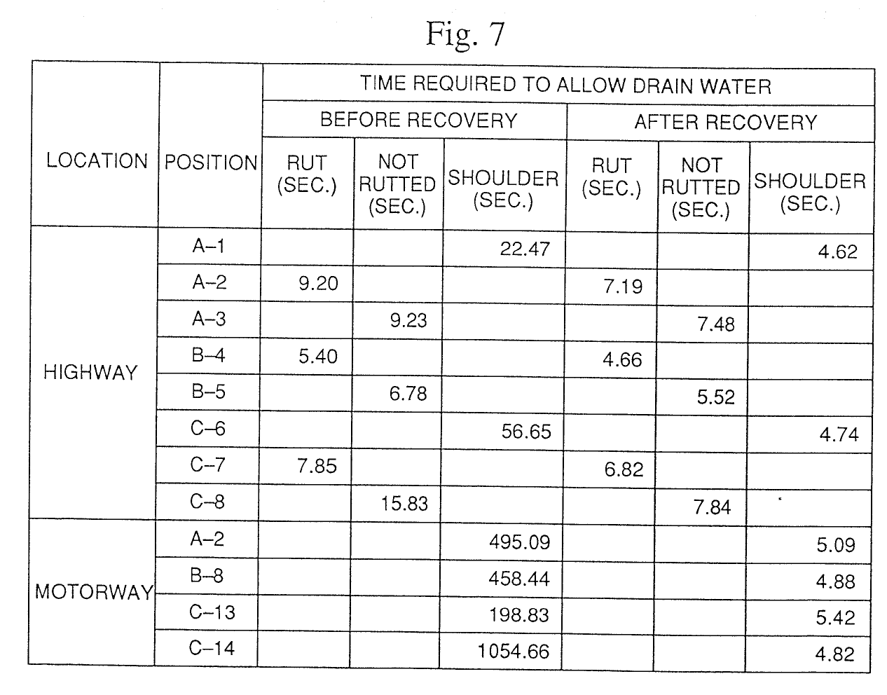

FIG. 7 shows the results of the water permeability recovery test for a wheel track, a non-wheel track, and a shoulder of a highway paved with a drainage material. The water permeability is recovered at all points, and the times required to drain water are shortened to less than 7 seconds. Particularly, for seriously clogged road shoulders, considerable effects are achieved.

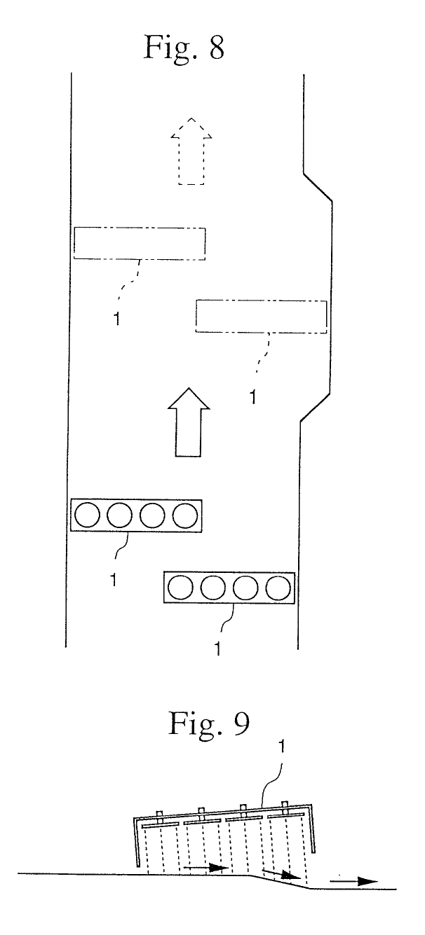

When the above device is used on a road, the width of the truck 1 may correspond to a traffic lane, and the process for one lane may be finished by running on the lane once. This may increase the size of the device, and the device would be unable to handle a widened lane such as a bus stop or a turnout. To avoid this, two trucks 1 may run diagonally in front and behind and right and left as shown in FIG. 8. When one traffic lane is 3.6 m in width, the width of the trucks 1 may be 2 meters, and the running trucks 1 may be separated in the front-to-rear direction and may be overlapped with respect to the transverse direction. At a widening point of the road, one of the trucks 1 may slide to the transverse direction. When the device discharges water jets onto a surface on which water still remains, the process is not effective. Therefore, after the first truck 1 discharges the water jet and the water is drained through the pavement surface layer 7, the second truck 1 discharges the water jet. The timing of the discharge of the water jet from the trucks 1 may be appropriately adjusted by changing the traveling speed of and the interval between the trucks 1.

At the shoulder of seriously clogged highways, a large amount of dust and soil may be ejected from the air voids to the road surface by the discharged water jet. Instead of sucking up the dust and soil by the vacuum evacuator 17, the dust and soil may be washed away to a side drain, or may be temporarily gathered and then removed. In this case, the truck 1 is slightly slanted to discharge the water jet obliquely as shown in FIG. 9. The discharged water jet naturally forms a water flow on the surface of the pavement surface layer, washing away the dust and soil effectively.

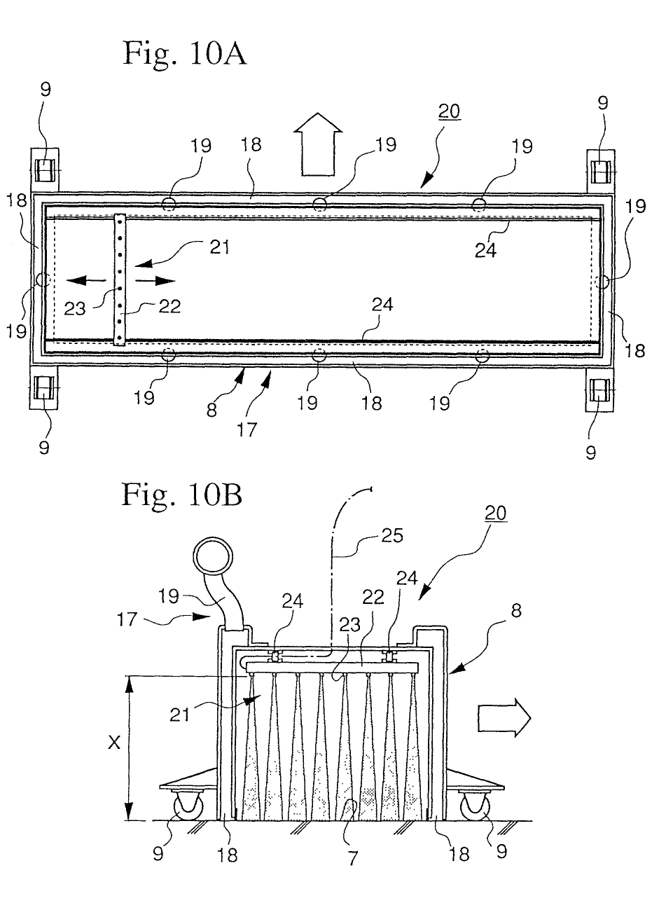

FIG. 10 shows the second embodiment of the device for recovering the permeability according to the present invention. On a truck 20 is loaded a nozzle mechanism 21, in which a number of nozzles 23 are attached to an underside of a pipe 22, and the pipe 22 can be reciprocated in the transverse direction. At the upper area within the casing 8, the pipe 22 is horizontally arranged along the traveling direction. Both ends of the pipe 22 are supported by guide rails 24 so that the pipe 22 can be reciprocated by a drive unit which is not shown. The pipe 22 is connected to a supply hose 25. While driving the truck 20 intermittently or continuously at a constant speed, the pipe 22 is reciprocated in the transverse direction, discharging the water jet from the nozzles 23 over the surface of the pavement surface layer 7. The standoff distance X is set to a value obtained by multiplying the nozzle diameter D₀ by 200 to 600 and the road surface is within the droplet flow region. The second embodiment achieves the same effect of recovering the function of the road surface layer as the first embodiment. As the nozzles 23, the orifice-type nozzle and the fan-type nozzle may be used together.

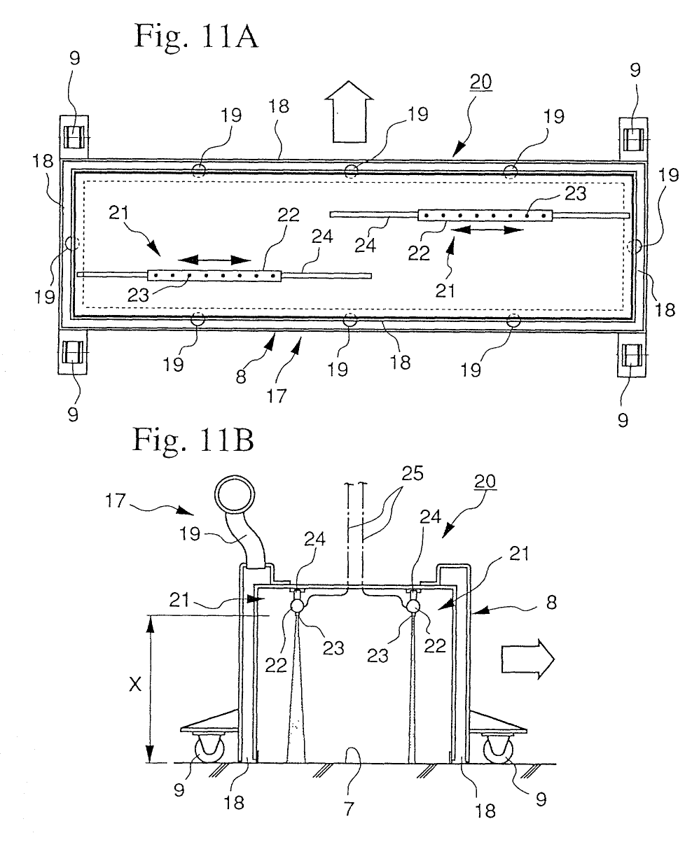

FIG. 11 shows the third embodiment of the device for recovering the permeability according to the present invention. The third embodiment is based on the second embodiment and modifies the nozzle mechanism 21 to be aligned along the transverse direction with respect to the casing 8 (the direction perpendicular to the traveling direction). The casing 8 includes two pipes 22 which are separated in the front-to-rear direction and are supported by guide rails 24 so that the pipes 22 can be reciprocated between the middle and the sides of the casing 8. While driving the truck 20 constantly, the pipes 22 are reciprocated in the transverse direction, discharging the water jet from the nozzles 23 over the surface of the pavement surface layer 7.

The device for recovering the permeability of the present invention may be modified and applied in various forms. For example, although in the first embodiment four rotors 11 in the nozzle mechanism 5 form a cross-shape, two, three, five rotors 11, or more may be arranged in a radial pattern. The number of the nozzles 6 attached to the rotors 11 is not limited to two, and may be changed. The types of the nozzles 6 may optionally be changed. The number of the nozzle mechanisms 5 is not limited to four, and the nozzle mechanisms 5 form a line, more than two lines, or a zigzag line. The drive mechanism for rotating the nozzle mechanisms 5 is not limited to the oil hydraulic motor 15 and a power transmission mechanism 16, and may employ other structures, for example, electric motors for driving the nozzle mechanisms 5 independently. Further, the second embodiment may include two or more pipes 22 which are synchronously or independently reciprocated. The third embodiment is not limited to the two pipes and may have one, three pipes, or more.

While in the above embodiments the trucks 1 and 20 are pulled or pushed by the self-propelled car 2, the trucks 1 and 20 may have drive units and may be self-propelled. Alternatively, the truck may be simply pushed by hand. In addition, the shape of the casing 8, the mechanism for adjusting the standoff distance X, and the presence or absence and the structure of the vacuum evacuator may be modified.

This invention is not limited to the above embodiment, and can be applied to other devices for processing an object, for example, a device for cleaning a semiconductor device or material, a device for removing burrs of a workpiece, and a device for cleaning a fishing net. In these devices, the water jet is discharged from a nozzle onto a surface of the object so that the surface of the object is within a droplet flow region of the water jet and that the droplets and globules cause water hammer. Preferably, the discharge pressure at the nozzle is within 20 to 70 MPa, and the dimensionless standoff distance obtained by dividing a real standoff distance between the nozzle and the object surface by a diameter of the nozzle is within 200 to 600. The water jet may be discharged obliquely to cause a water flow in one direction on the surface of the object.

This invention may be embodied in other forms or carried out in other ways without departing from the spirit thereof The present embodiments are therefore to be considered in all respects illustrative and not limiting, the scope of the invention being indicated by the appended claims, and all modifications falling within the meaning and range of equivalency are intended to be embraced therein.

What is claimed is:

1. A method for recovering water permeability of a pavement surface layer of drainage or water permeable pavement by removing clogging of air voids in the pavement surface layer, comprising the step of:
discharging a water jet at a high pressure from a nozzle onto a surface of the pavement surface layer so that the surface of the pavement surface layer is within a droplet flow region of the water jet and that droplets and globules in the droplet flow region enter the air voids in the pavement surface layer to cause water hammer which removes the clogging of the pavement surface layer.

2. A method according to claim 2, wherein a discharge pressure at the nozzle is within 20 to 70 MPa, and a dimensionless standoff distance obtained by dividing a real standoff distance between the nozzle and the pavement surface layer by a diameter of the nozzle is within 200 to 600.

3. A method according to any one of claims 1 and 2, wherein the water jet is discharged obliquely to cause a water flow in one direction on the surface of the pavement surface layer, said water flow washing away contaminants which are pushed out from the air voids in the pavement surface layer to the surface by the water hammer.

4. A device for recovering water permeability of a pavement surface layer of drainage or water permeable pavement by removing clogging of air voids in the pavement surface layer, comprising:
a truck for running on a target paved surface; and
a nozzle mechanism having a nozzle for discharging a water jet at a high pressure,
wherein a standoff distance between the nozzle and the pavement surface layer is set so that a surface of the pavement surface layer is within a droplet flow region of the water jet.

5. A device according to claim 4, wherein said nozzle mechanism comprises:
a rotational axis; and
a plurality of rotors attached to said rotational axis to form a radial pattern,
wherein said nozzles are attached to undersides of said rotors, and as said rotational axis is rotated, said nozzles draw circles in a plane parallel to the surface of the pavement surface layer.

6. A device according to claim 5, wherein a plurality of said nozzle mechanisms are aligned perpendicularly to a traveling direction of said truck, the intervals between the nozzle mechanisms are determined so that the circles, which are drawn by the water jets from said nozzles as said nozzle mechanisms are rotated, overlap.

7. A device according to claim 4, wherein said nozzle mechanism comprises:
a pipe extending horizontally,
wherein a plurality of said nozzles are attached to an underside of said pipe at predetermined intervals in the direction of extension of said pipe, and said pipe is reciprocated so that the nozzles are reciprocated in a plane parallel to the surface of the pavement surface layer.

8. A device according to any one of claims 4 to 7, wherein a plurality of said nozzles are attached to said nozzle mechanism, and orifice-type nozzles and fan-type nozzles are used together as said nozzles.

9. A device according to any one of claims 4 to 8, further comprising a casing, which is open at the bottom, for including said nozzle mechanism.

10. A device according to claim 9, further comprising a vacuum evacuator for evacuating said casing.

11. A method for processing or cleaning an object, comprising the step of:
discharging a water jet at a high pressure from a nozzle onto a surface of the object so that the surface of the object is within a droplet flow region of the water jet and that droplets and globules cause water hammer.

12. A method according to claim 11, wherein a discharge pressure at the nozzle is within 20 to 70 MPa, and a dimensionless standoff distance obtained by dividing a real standoff distance between the nozzle and the object surface by a diameter of the nozzle is within 200 to 600.

13. A method according to any one of claims 11 and 12, wherein the water jet is discharged obliquely to cause a water flow in one direction on the surface of the object.
